(19) United States
(12) Patent Application Publication
(10) Pub. No.: US 2006/0176893 A1
(43) Pub. Date: Aug. 10, 2006

(54) Method of dynamic queue management for stable packet forwarding and network processor element therefor

(76) Inventors: Yoon-Jin Ku, Seongnam-si (KR); Jong-Sang Oh, Suwon-si (KR); Byung-Chang Kang, Yongin-si (KR); Yong-Seok Park, Seongnam-si (KR)

Correspondence Address: Robert E. Bushnell;Suite 300, 1522 K Street, N.W., Washington, DC, 20005-1202, US

(21) Appl. No.: 11/326,326

(22) Filed: Jan. 6, 2006

(30) Foreign Application Priority Data
Feb. 7, 2005 (KR) 2005-11429

(51) Int. Cl. H04L 12/56

(52) U.S. Cl. 370/412; 370/392

(57) ABSTRACT

In a method of dynamic queue management for stable packet forwarding and a network processor element therefor, a network processor of a switch/router can stably assign a packet descriptor for packet forwarding of a local area network/wide are network (LAN/WAN) interface. The method comprises the steps of: determining whether there is a corrupted link for the purpose of processing packets for the forwarding; setting free a packet buffer and a descriptor stored in a queue of a port corresponding to the corrupted link; detecting a normal link to number corresponding output ports; and queuing the packets and descriptors corresponding to the packets to a forwarded one of the calculated ports.

### CLAIM OF PRIORITY

This application makes reference to and claims all benefits accruing under 35 U.S.C. §119 from an application for “METHOD OF DYNAMIC QUEUE MANAGEMENT FOR STABLE PACKET FOR WARDING AND NETWORK PROCESSOR ELEMENT THEREFOR” earlier filed in the Korean Intellectual Property Office on Feb. 7, 2005 and there duly assigned Serial No. 2005-11429.

### BACKGROUND OF THE INVENTION

1. Technical Field

The present invention relates to a method of dynamic queue management for stable packet forwarding and a network processor element therefor, and more particularly, a method and network processor element by means of which a network processor of a switch/router can stably assign a packet descriptor for packet forwarding of a local area network/wide are network (LAN/WAN) interface.

2. Related Art

In general, different types of traffic having different sizes and transmission rates flow in the Internet. In order to facilitate and efficiently manage the traffic flow in the Internet, queue management and scheduling techniques are used.

As a recent trend, according to the development of transmission technologies, queue management and scheduling capable of ensuring a higher transmission rate while supporting various services (e.g., MPLS, MPLS VPN, IP VPN and QoS) are gradually becoming more important in order to accommodate an explosive increase in Internet traffic.

Such queue management and scheduling are processed by a switch/router. However, a router for processing packet forwarding acts frequently as a source of a network bottleneck. Accordingly, research is being actively carried out with respect to network processor technologies that have the advantages of programmability to afford various services as well as the ability to process packets at a high rate. Attempts have been made to increase bandwidth in order to dissolve a latency problem in wide applications by enabling networking processes, which have been processed via software, to be executed via hardware.

For the purpose of this, a network processor has major functions, which will be described as follows:

Packets are processed according to functions, such as packet classification, packet modification, queue/policy management and packet forwarding.

Packet classification is performed to classify packets based upon destination characteristics, such as address and protocol, and packet modification is performed to modify packets to conform to IP, ATM, or other protocols. For example, time-to-live fields are generated in an IP header.

Queue/policy management reflects design strategies in packet queuing, packet de-queuing and scheduling of packets for specific applications. Packet forwarding is performed for data transmission/reception toward/from a switch fabric or higher application, and for packet forwarding or routing toward a suitable address.

The network processor can interface with an external physical layer/data link layer as well as another network processor that performs an auxiliary function. The network processor also interfaces with a switch fabric to manage packet transmission/reception.

In general, the network processor is associated with physical layer/data link layer hardware to execute packet forwarding. A packet received by the network processor is stored in a packet buffer of an SDRAM. Information related to the received packet, such as packet size and the location of an SDRAM storing the packet, is managed by a packet descriptor. The packet descriptor is located in a packet descriptor pool of an SRAM. The network processor manages this packet descriptor before transmitting the packet received by a scheduler to a corresponding output port, which is referred to as “queue management.”

The network processor, after receiving a packet from the physical layer/data link layer hardware, assigns a packet descriptor from the packet descriptor pool. The network processor executes forwarding table lookup for the received packet to select an output port. When the output port is selected, the received packet is queued together with the packet descriptor via queue management. When the corresponding output port of the received packet is selected by the scheduler for scheduling output ports, the queue management de-queues the packet descriptor. When the received packet is transmitted to the corresponding output port, the packet descriptor is set free and returned to the packet descriptor pool. This is a process in which the packet descriptor is assigned and returned for reuse in packet forwarding.

The packet descriptor pool is shared so that the packet descriptor of the received packet is assigned to several ports. If burst packets for transmission to a high rate local area network/wide are network (LAN/WAN) output port are stored in a queue, and if it is reported that a link of the high rate output port is disconnected, the received packets are already assigned with a packet descriptor and stacked in the queue. If other burst packets for transmission to other output ports are received during this period, the packet descriptor pool is temporarily short of available packet descriptors. This may cause a problem in that all of the received packets are lost.

### SUMMARY OF THE INVENTION

The present invention has been developed to solve the foregoing problems of the prior art, and it is therefore an object of the present invention to provide a method of dynamic queue management for stable packet forwarding and a network processor element therefor. More particularly, it is an object of the present invention to provide a method and a network processor element by means of which, even if at least one link is down, a port of another normal link can be utilized to stably queue a packet descriptor for packet forwarding in a local area network/wide are network (LAN/WAN) interface.

According to an aspect of the invention for realizing the above objects, there is provided a method of dynamic queue management for packet forwarding, the method comprising the steps of: determining whether there is a corrupted link in order to process packets for the forwarding; setting free a packet buffer and a descriptor stored in a queue of a port corresponding to the corrupted link; detecting a normal link to calculate the number of corresponding output ports; and queuing the packets and corresponding descriptors to a forwarded one of the calculated ports.

The method further comprises: calculating a packet descriptor pool assigned to each of the calculated ports based upon the number of the ports to be equally divided by maximum queue capacity.

The method further comprises: calculating a minimum queue capacity by applying the number of packet descriptors queued to the individual ports having the maximum queue capacity and the number of packet descriptors, which are designed to ensure a bandwidth appropriate for the traffic.

The method further comprises: calculating the use rate of each queue based upon the minimum queue capacity and packet descriptor pool size; and calculating available queue capacity based upon the maximum queue capacity, the minimum queue capacity, and the use rate.

The method further comprises: determining whether the number of queued packet descriptors is at least larger than the available queue capacity, and according to a result of the determination, setting free a packet buffer and a descriptor stored in a queue of at least one normal port for packet reception.

The method further comprises: determining whether the number of the queued packet descriptors is equal to or less than the available queue capacity, and according to a result of the determination, queuing received packets and packet descriptors corresponding to the received packets.

Preferably, the step of setting free a packet buffer and a descriptor further comprises: returning the packet descriptor to a packet descriptor pool.

According to another aspect of the invention for realizing the above objects, there is provided a method of dynamic queue management for packet forwarding, the method comprising the steps of: calculating output ports corresponding to normal link in order to process packets for the forwarding; equally dividing the output ports in accordance with a maximum queue capacity assigned to individual output ports based upon the number of the ports; and queuing the packets and descriptors corresponding to the packets to a forwarded one of the output ports having assigned queue capacity.

The method further comprises: calculating minimum queue capacity by applying the number of packet descriptors queued to the individual ports having the maximum queue capacity and the number of packet descriptors, which are designed to ensure bandwidth according to traffic.

The method further comprises: calculating the use rate of each queue based upon the minimum queue capacity and packet descriptor pool size; and calculating available queue capacity based upon the maximum queue capacity, the minimum queue capacity, and the use rate.

The method further comprises: determining whether the number of queued packet descriptors is at least larger than the available queue capacity, and according to a result of the determination, setting free a packet buffer and a descriptor stored in a queue of at least one normal port for packet reception.

The method further comprises: determining whether the number of the queued packet descriptors is equal to or less than the available queue capacity, and according to a result of the determination, queuing received packets and packet descriptors corresponding to the received packets.

According to still another aspect of the invention for realizing the above objects, there is provided a network processor element for dynamic queue management for stable packet forwarding, the network processor element comprising: a receive engine for storing received packets in packet buffers and assigning the received packets to packet descriptors; a forwarding engine for looking up a forwarding table for the packets and detecting output ports; a scheduling engine for selecting the output ports, which are supposed to transmit the packets, according to a scheduling policy; a queue management for confirming at least one output port having a corrupted link, setting free a packet buffer and a packet descriptor from the output port having the corrupted link, calculating ports having a normal link, and queuing the packets to packet buffers and packet descriptors in ports forwarded by calculating the number of ports having the normal link; and a transmit engine for transmitting the packets via the ports queued by the queue management and returning the packet descriptors to a packet descriptor pool.

Preferably, the queue management calculates a maximum queue depth by equally dividing packet descriptor pool size to the individual ports having the normal link, and calculates a minimum queue depth based upon the number of queued packet descriptors and the number of packet descriptors according to bandwidth ensured to the individual ports in order to calculate available queue depth of the individual ports according to the use rate of the individual ports of the packet descriptor pool with respect to the minimum queue depth.

Preferably, the queue management determines whether the number of queued packet descriptors is at least larger than the available queue capacity, and according to a result of the determination, sets free a packet buffer and a descriptor stored in a queue of at least one normal port for packet reception.

Preferably, the queue management determines whether the number of queued packet descriptors is equal to or less than the available queue capacity, and according to a result of the determination, queues received packets and packet descriptors corresponding to the received packets.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating a switch/router system of dynamic queue management for stable packet forwarding according to the invention;

FIG. 2 is a block diagram illustrating a network processor element according to the invention;

FIG. 3 is an illustration of an operation status of an SDRAM and an SRAM by a network processor according to the invention; and

FIG. 4 is a flowchart of a method of dynamic queue management by queue management of a network processor to dynamically assign the queue depth of each queue according to a preferred embodiment of the invention.

### DETAILED DESCRIPTION OF THE INVENTION

The following detailed description will present a method of dynamic queue management for stable packet forwarding and a network processor element therefor according to the invention with reference to the accompanying drawings.

A dynamic queue management system of the invention can be explained with a switch/router arrangement mounted with a network processor.

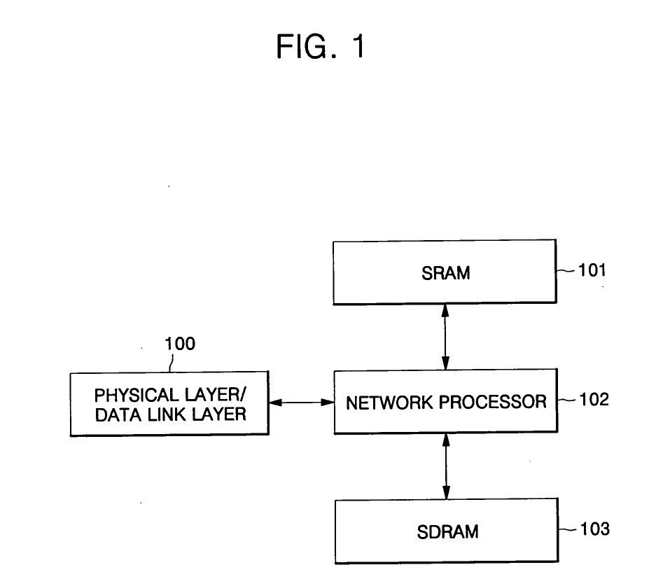

FIG. 1 is a block diagram of a switch/router system illustrating dynamic queue management for stable packet forwarding according to the invention.

Referring to FIG. 1, the switch/router mounted with a network processor, to which the invention is applied, includes a physical layer/data link layer 100, a network processor 102, an SRAM 101, and an SDRAM 103.

The physical layer/data link layer 100 is a common network element for supporting a link matching function for various network interfaces of the switch/router. Examples of the physical layer/data link layer 100 include an Ethernet Medium Access Control (MAC), PSO Framer, ATM Framer, and HDLC controller.

The SRAM 101 stores various information, including packet size, packet storage location and forwarding table, which are necessary for the network processor 102 to execute packet processing.

The SDRAM 103 stores a packet received from the physical layer/data link layer 100.

The network processor 102 undertakes general packet processing. That is, when a packet is introduced through the physical layer/data link layer 100 into the network processor 102, the packet is separated into a header and data, which are processed differently according to packet type. In addition, the network processor 102 undertakes sub-processing, such as forwarding table lookup, security, traffic engineering and QoS. Basically, the network processor 102 selects an output port for the header and data stored in the SDRAM 103 with reference to a forwarding table, and outputs the header and data via the corresponding port. If the packet is not listed in the forwarding table, it may be discarded or processed according to a policy-based determination.

If an output port according to the forwarding table has a corrupted link, the corrupted link cannot queue a packet. If queued by the corrupted link, the packet is lost and cannot be transmitted to a corresponding address. However, the network processor 102 prevents any loss in received packets. That is, when any port having a corrupted link is found, an optimal queuing procedure is executed by setting free a packet buffer and a packet descriptor of a queue mapped to the corresponding port, and assigning the queue to an uncorrupted normal port so that the packet can be transmitted to a corresponding IP address without being lost. Herein, “setting free” means making empty or evacuating a packet buffer space of the SDRAM 103 and/or a packet descriptor space of the SRAM 101.

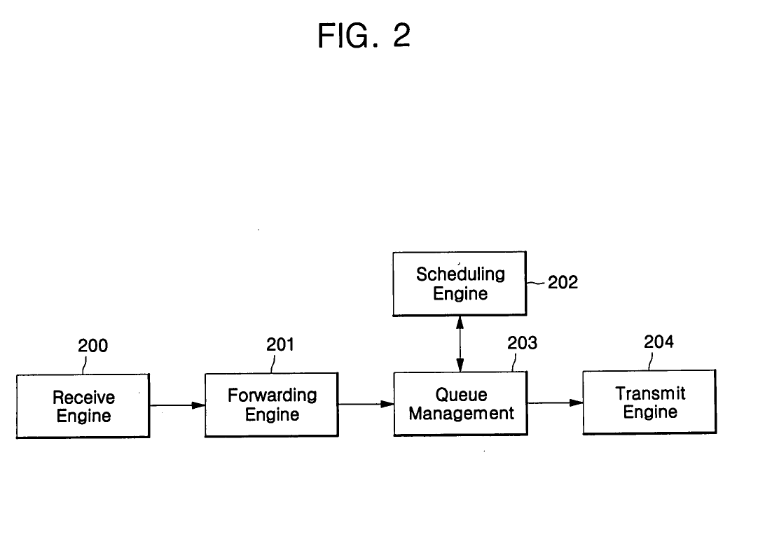

FIG. 2 is a block diagram illustrating a network processor element according to the invention.

An internal configuration of the network processor 102 will now be explained with reference to FIG. 2.

The network processor 102 includes a receive engine 200, a forwarding engine 201, a scheduling engine 202, a queue management 203 and a transmit engine 204.

The receive engine 200 is an engine which detects a port by which a packet is received from the physical layer/data link layer 100, and moves and stores the received packet into a packet buffer. The receive packet 200 also functions to assign a packet descriptor from a packet descriptor pool for the received packet.

The forwarding engine 201 is an engine which executes a forwarding table lookup with respect to the packet sent from the receive engine 200 in order to find a corresponding output port.

The scheduling engine 202 is an engine which selects an output port, by which the packet is to be transmitted, according to internal policy.

The queue management 203 functions to queue a packet to a queue of the SRAM 101 and the SDRAM 103 corresponding to an output port, and to read a packet from the queue of the output port. The queue management 203 also determines whether or not an output port is normal, and if the output port is corrupted, queue management 203 sets free a packet buffer of the SDRAM 103 and a packet descriptor of the SRAM 101 which are stored in the queue of the corresponding port, and returns the packet descriptor to a packet descriptor pool (not shown) of the SRAM 101.

The packet descriptor pool has packet descriptors prepared sequentially from head to tail, and provides necessary and corresponding packet descriptors to be assigned according to the order of queuing when the SRAM 101 queues packets. A packet descriptor has a priority value given according to the order of packet reception, so that a packet can be queued and de-queued to the SDRAM 103 and the SRAM 101. Thus, a packet descriptor queued to the SRAM 101 is identical to an actual packet save area of the SDRAM 103. The packet descriptor has the packet size of a packet queued to the SDRAM 103, buffer handle (i.e., buffer address in use for storing a packet), and descriptor identification information for a next packet.

In addition, the packet descriptor pool detects ports having a normal uncorrupted link so as to calculate the number of normal link ports, and queues the packet to a packet buffer and a packet descriptor in a port forwarded based upon the calculated number.

That is, when packet descriptor pool size is equally divided into individual ports of normal links so as to calculate the maximum queue depth and minimum queue depth based upon the number of queued packet descriptors and the number of packet descriptors according to bandwidth ensured to ports, available queue depth for each port is calculated according to the use rate of each port of the packet descriptor pool with respect to the minimum queue depth.

If it is confirmed that the queued packet descriptors outnumber the available queue capacity, the packet buffer and the descriptor stored in the queue of at least one normal port for packet reception are set free. Then, queuing for normal ports is executed. However, if it is confirmed that the queued packet descriptors number less than the available queue capacity, the received packet and the corresponding packet descriptor are queued in a corresponding memory area.

The transmit engine 204 functions to transmit a packet to a corresponding output port, and then to return a packet descriptor, which was assigned to the transmitted packet, to the packet descriptor pool.

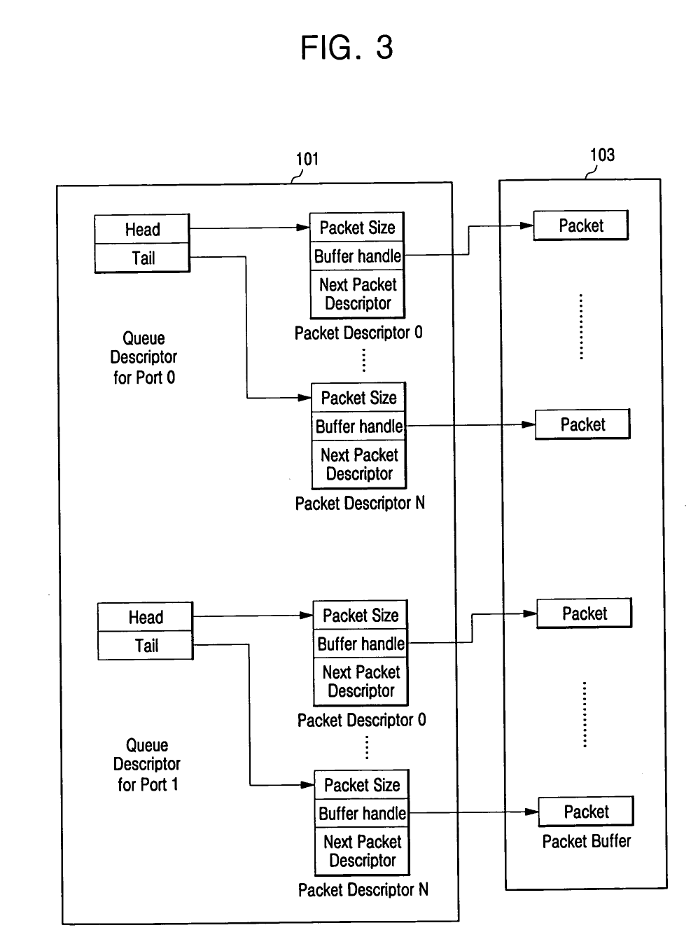

FIG. 3 is an illustration of an operation status of an SDRAM and an SRAM by a network processor according to the invention.

A method of managing packet descriptors by the queue management 203 will be described with reference to FIG. 3.

The queue management 203 queues a received packet with its output port, determined by the forwarding engine 201, in a packet buffer of the SDRAM 103, and a packet descriptor of the SRAM 101 mapped in the buffer in a corresponding location according to priority. Packet descriptors are classified according to ports, and are queued in the SRAM 101 after being taken from a packet descriptor pool. When a packet descriptor of the SRAM 101 is set free according to management procedures, it is returned to the packet descriptor pool.

Herein, the packet descriptor pool has such packet descriptors provided from head to tail, and provides a necessary and corresponding packet descriptor to be assigned according to the order of queuing when the SRAM 101 queues a packet. The packet descriptor has packet size of a packet queued to the SDRAM 103, a buffer handle (i.e., buffer address in use for storing a packet), and descriptor identification information for a next packet.

Therefore, queues exist one by one in each output port, and when the forwarding engine 201 determines an output port of a received packet, the queue management 203 connects the received packet to the end of a packet descriptor list managed by a queue of the corresponding output port. In this way, the queue management 203 stores the received packet in the queue up to a point in time at which the packet can be transmitted via a specific output port enabled by the scheduling engine 202. When transmission via the output port is enabled by the scheduling engine 202, the queue management 203 takes packet descriptors from head to tail out of the queue of the output port so as to deliver the packet descriptors to the transmit engine 204.

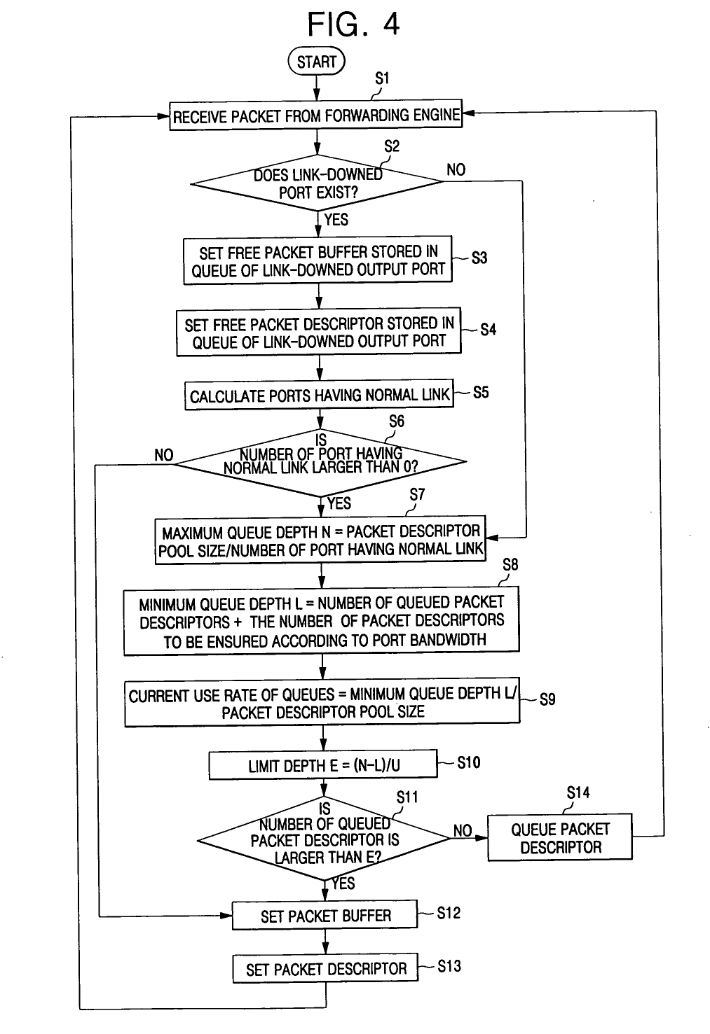

FIG. 4 is a flowchart of a method of dynamic queue management by queue management of a network processor to dynamically assign the queue depth of each queue according to a preferred embodiment of the invention.

A queue management method by the queue management 203 of the invention will now be described with reference to FIG. 4. In particular, procedures for queuing received packets according to the invention after the queue management 203 receives the received packets with their output ports determined by the forwarding engine 201 will be described.

The queue management 203 receives a packet having an output port selected by the forwarding engine 201 in S1, and determines whether any disconnected link due to corruption exists in any of output ports managed by the network processor 102 in S2. If there is a port having a disconnected link, the queue management 203 sets free a packet buffer of the SDRAM 103 assigned for received packets stored in a queue of the port in S3, and sets free corresponding packet descriptors from the SRAM 101 to return the descriptors to the packet descriptor pool in S4. Then, the received packets stored in the queue of the output port having a disconnected link are set free from the SRAM 101 and the SDRAM 103, and are then discarded from the network processor 102.

Then, an optimal limit depth (queue capacity) available for a queue corresponding to the output port is determined. For this purpose, from output ports that are detected by the network processor 102, those having a normal link are calculated in S5. If output ports more than zero have a normal link as determined in S6, the packet descriptor pool size is equally divided into individual ports having a normal link. That is, the total size of the packet descriptor pool is divided by the number of output ports having a normal link. A maximum depth N is determined from the share of the division in S7. The maximum depth N of the queue is a value produced by equally assigning the packet descriptor pool to the individual ports.

A minimum depth L of the output ports is determined by adding the number of packet descriptors to be ensured according to port bandwidth to the number of packet descriptors currently queued to output port queues in S8. For example, in the case of a fast Ethernet, the number of packet descriptors to be ensured is set to 10, and in the case of a Gigabit Ethernet, it is set to 100. The minimum depth L of output ports is the number of packet descriptors able to be stored in a stable manner for the queues of ports having a normal link in any situation.

Current use rate U of output port queues with respect to the packet descriptor pool is produced by dividing the minimum depth L of the output port queues by the packet descriptor pool size. This value is used to assign a portion of the packet descriptor pool, which is not used by the output port queues, to the output port queues according to use rate in S9.

An optimal limit depth E available for the output port queues is produced in S10 by multiplying a value N−L by the current use rate U of the packet descriptor pool, in which N is the maximum depth of the output port queues and L is the minimum depth of the output port queues. The optimal depth E available for the output port queues means the maximum number of packet descriptors able to be stored in the output port queues.

If the number of packet descriptors currently queued to an output port queue is equal to the available optimal depth E, this queue can no longer execute queuing, and packets are discarded. The optimal limit depth E available for the output port queue enables the packet descriptor pool to be equally used by the queues of the individual output ports, considering the bandwidth of the individual ports and the use rate of the output ports determined by forwarding the packets in S11.

If the number of packet descriptors currently queued to an output port queue is equal to or larger than the available limit depth E, no more packet descriptors can be queued to the output port queue. Thus, a packet buffer of the SDRAM 103 assigned for a received packet is set free in S12, and a corresponding packet descriptor is also set free so as to return corresponding descriptors to the packet descriptor pool in S13. The received packet is from the network processor. However, queues of other output ports having a normal link can continuously queue packet descriptors up to the maximum depth N so that the network processor can stably forward the packets.

However, if the queue depth P of a current output port is smaller than the maximum depth N, packet descriptors from the packet descriptor pool are brought to a queue of the output port so as to execute queuing in S14.

If the number of output ports having a normal link is zero as determined in S6, all of the received packets are discarded, and then S12 and S13 are executed. If there are no disconnected output ports having a corrupted link as determined in S2, procedures for calculating the maximum depth L of the output port queues, the minimum depth L of the output port queues, the current use rate U of the packet descriptor pool, and the available limit depth E are carried out in S7 to S10.

As described above, even though at least one link is corrupted, the present invention can allocate packet descriptors in a stable manner for packet forwarding of the LAN/WAN interface by utilizing another normal link.

Although at least one link is corrupted, the invention can utilize another normal link to stably allocate packet descriptors for packet forwarding of the LAN/WAN interface so as to maximize efficient application of the packet descriptor pool, as well as to improve QoS.

While the present invention has been shown and described in connection with the preferred embodiments, it will be apparent to those skilled in the art that modifications and variations can be made without departing from the spirit and scope of the invention as defined by the appended claims.

What is claimed is:

1. A method of dynamic queue management for packet forwarding, the method comprising the steps of:
determining whether there is a corrupted link in order to process packets for the forwarding;
setting free a packet buffer and a descriptor stored in a queue of a port corresponding to the corrupted link;
detecting a normal link so as to calculate a number of corresponding output ports; and
queuing the packets and corresponding descriptors to a forwarded one of the corresponding output ports.

2. The method according to claim 1, further comprising the step of calculating a packet descriptor pool assigned to each of the corresponding output ports based upon a number of the ports to be equally divided by a maximum queue capacity.

3. The method according to claim 2, further comprising the step of calculating a minimum queue capacity by applying a number of packet descriptors queued to individual ports having the maximum queue capacity and the number of packet descriptors which are designed to ensure bandwidth according to traffic.

4. The method according to claim 3, further comprising the steps of:
calculating a use rate of each queue based upon the minimum queue capacity and a packet descriptor pool size; and
calculating available queue capacity based upon the maximum queue capacity, the minimum queue capacity, and the use rate.

5. The method according to claim 4, further comprising the step of determining whether a number of queued packet descriptors is larger than the available queue capacity, and setting free a packet buffer and a descriptor stored in a queue of at least one normal port for packet reception in accordance with a result of the determining step.

6. The method according to claim 4, further comprising the step of determining whether a number of the queued packet descriptors is no greater than the available queue capacity, and queuing received packets and packet descriptors corresponding to the received packets in accordance with a result of the determining step.

7. The method according to claim 1, wherein the step of setting free the packet buffer and the descriptor further comprises returning the packet descriptor to a packet descriptor pool.

8. A method of dynamic queue management for packet forwarding, the method comprising the steps of:
calculating a number of output ports corresponding to normal link in order to process packets for the forwarding;
equally dividing the number of output ports into a maximum queue capacity assigned to individual output ports based upon the number of the ports; and
queuing the packets and descriptors corresponding to the packets to a forwarded one of the output ports having an assigned queue capacity.

9. The method according to claim 8, further comprising the step of calculating a minimum queue capacity by applying a number of packet descriptors queued to the individual ports having the maximum queue capacity and a number of packet descriptors which are designed to ensure bandwidth according to traffic.

10. The method according to claim 9, further comprising the steps of:
calculating a use rate of each queue based upon the minimum queue capacity and a packet descriptor pool size; and
calculating available queue capacity based upon the maximum queue capacity, the minimum queue capacity, and the use rate.

11. The method according to claim 10, further comprising the step of determining whether a number of queued packet descriptors is larger than the available queue capacity, and setting free a packet buffer and a descriptor stored in a queue of at least one normal port for packet reception in accordance with a result of the determining step.

12. The method according to claim 10, further comprising the step of determining whether a number of the queued packet descriptors is no greater than the available queue capacity, and queuing received packets and packet descriptors corresponding to the received packets in accordance with a result of the determining step.

13. A network processor element for dynamic queue management for stable packet forwarding, comprising:
a receive engine for storing received packets in packet buffers and for assigning the received packets to packet descriptors;
a forwarding engine for looking up a forwarding table for the packets and for detecting output ports;
a scheduling engine for selecting the output ports which are supposed to transmit the packets according to a scheduling policy;
a queue management for confirming at least one output port having a corrupted link, for setting free a packet buffer and a packet descriptor from said at least one output port having the corrupted link, for calculating ports having a normal link, and for queuing the packets to packet buffers and packet descriptors in ports forwarded by calculating the number of ports having the normal link; and
a transmit engine for transmitting the packets via the ports queued by the queue management, and for returning the packet descriptors to a packet descriptor pool.

14. The network processor according to claim 13, wherein the queue management calculates a maximum queue depth by equally dividing a packet descriptor pool size to the individual ports having the normal link, and calculates a minimum queue depth based upon the number of queued packet descriptors and the number of packet descriptors according to a bandwidth ensured to the individual ports in order to calculate available queue depth of the individual ports according to the use rate of the individual ports of the packet descriptor pool with respect to the minimum queue depth.

15. The network processor according to claim 14, wherein the queue management determines whether the number of the queued packet descriptors is larger than the available queue capacity, and sets free a packet buffer and a descriptor stored in a queue of at least one normal port for packet reception in accordance with a result of the determination.

16. The network processor according to claim 14, wherein the queue management determines whether the number of the queued packet descriptors is no greater than the available queue capacity, and queues received packets and packet descriptors corresponding to the received packets in accordance with a result of the determination.
